(19) United States
(12) Patent Application Publication
(10) Pub. No.: US 2008/0081609 A1
(43) Pub. Date: Apr. 3, 2008

(54) METHOD AND SYSTEM FOR ASSOCIATING A USER PROFILE TO A SIM CARD

(75) Inventors: John M. Burgan, North Palm Beach, FL (US); Mohammad Besharat, Lake Villa, IL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/537,204

(22) Filed: Sep. 29, 2006

(51) Int. Cl. H04Q 7/20

(52) U.S. Cl. 455/425

(57) ABSTRACT

A method (10) and system (200) for associating a user profile (39) to SIM card (38) can include a processor (202) that is controlled under an operating system allowing multiple profiles. The processor extract (12) subscriber identity information from the SIM card when the SIM card is coupled to the wireless communication device, associate (14) at least a portion of the subscriber identity information from the SIM card with at least a predetermined profile stored on the wireless communication device, and enable (16) access to the predetermined profile only when the portion of the subscriber identity information is associated with the predetermined profile stored on the wireless communication device. The method can store (18) separate profiles on the wireless communication device for each SIM card used on the wireless communication device or store separate multiple profiles on the wireless communication device for each SIM card used.

### FIELD

This invention relates generally to communication systems, and more particularly to a method and system of associating or adapting a profile on a wireless communication device to a Subscriber Identity Module (SIM) card.

### BACKGROUND

Cell phones supporting SIM cards (such as GSM or iDEN phones) are becoming more popular as the phones that supported hardware Electronic Serial Numbers (ESNs) such as AMPS and TDMA are becoming obsolete. One of the most desired features of a SIM card-based phone is the ability it gives the user to own multiple phones and easily transfer the user's account ID or identifier to any phone he or she owns at will. For example, a user may own a rugged industrial phone for work, but own a smaller more elegant phone for social use. This enables a contractor to carry a rugged phone that can withstand rough service and harsh environments without damage during the day, but to switch to a small stylish phone when the contractor goes out to dinner or a party with his or her family.

Many of the higher end smart phones (Windows CE phones, Symbian phones, or Palm Phones) are very expensive. They might be too expensive for a company to buy one for every single employee, or for a family to buy for every family member. Perhaps only a small number of smart phones are purchased for a whole company to share on as needed basis and only one smart phone is bought for a family to share. These usage scenarios favor SIM cards by allowing the user to remove the SIM card from their smart phone when the user is done using the smart phone features, and allows the user to switch back to the user's personal phone. In this manner, the user can leave the smart phone behind for another person to use (perhaps on another work shift).

The SIM card contains the account ID and therefore the phone number of the user. However it does not store any user settings or customization for the smart phone. For instance, in the case where a construction company that issues smart phones to estimators to use on the job, the estimator can put his or her SIM card (account and phone number) into a phone to use in the field and remove it when he or she returns to the office. However, any custom applications loaded into the smart phone (construction estimating program for example), or any personal settings configured to the user's personal tastes (alerts, pictures, etc), are left in the phone for the next user to see. The next user of the phone (family member, co-worker) would then reconfigure the settings to their personal preferences, overwriting the first user's settings. Since the smart phone supports installable applications, alerts, pictures, and other features, it is impractical to use a SIM card to try to store the customized user settings for a smart phone.

Furthermore, most smart phones support synchronizing (sync) with a personal computer or other computing device, but typical smart phone operating systems (Windows CE for example) use sync to back up data only. Existing phones do not allow different profiles to be synced to the same device based on ID or login. In fact, it is awkward to sync the phone to more than one PC, or more than one device to a single PC.

### SUMMARY

Embodiments in accordance with the present invention can enable storage of multiple user profiles in a smart phone, and the locking of such profiles to the user by using a user's SIM card ID.

In a first embodiment of the present invention, a method of adapting a phone profile in a wireless communication device to a Subscriber Identity Module (SIM) card can include the step of extracting subscriber identity information from a SIM card when the SIM card is coupled to the wireless communication device, associating at least a portion of the subscriber identity information from the SIM card with at least a predetermined profile stored on the wireless communication device, and enabling access to the predetermined profile only when the portion of the subscriber identity information is associated with the predetermined profile stored on the wireless communication device. The method can further include storing separate profiles on the wireless communication device for each SIM card used on the wireless communication device or alternatively or optionally storing separate multiple profiles on the wireless communication device for each SIM card used on the wireless communication device. Separate multiple profiles can be created for example by creating a profile for work and a profile for home for a single SIM card used on the wireless communication device. The step of associating can include associating subscriber identity information with settings and applications for a particular user corresponding to the predetermined profile. For example, the subscriber identity information can be associated with a user's desktop, bookmarks, applications, or short-cuts a particular user has corresponding to the predetermined profile stored on the wireless communication device. The method can further include the step of denying access to the predetermined profile when a SIM card other than the SIM card containing the portion of the subscriber identity information is coupled to the wireless communication device. The method can further include synchronizing with an external computing device only information associated with the predetermined profile when the SIM card containing the portion of the subscriber identity information is coupled to the wireless communication device. The method can also prompt a user for the creation of a new profile with a default profile upon the coupling of a previously unseen SIM card with the wireless communication device. Note, the method can also enable access to public files notwithstanding a coupling of a SIM card with the wireless communication device.

In a second embodiment of the present invention, a system of adapting a phone profile in a wireless communication device to a Subscriber Identity Module (SIM) card can include a transceiver and a processor coupled to the transceiver. The processor can be programmed to extract subscriber identity information from the SIM card when the SIM card is coupled to the wireless communication device, associate at least a portion of the subscriber identity information from the SIM card with at least a predetermined profile stored on the wireless communication device, and enable access to the predetermined profile only when the portion of the subscriber identity information is associated with the predetermined profile stored on the wireless communication device. The processor can be further programmed to store separate profiles on the wireless communication device for each SIM card used on the wireless communication device or store separate multiple profiles on the wireless communication device for each SIM card used on the wireless communication device. The system can also associate at least a portion of the subscriber identity information by associating subscriber identity information with settings and applications for a particular user corresponding to the predetermined profile. For example, the system can associate at least a portion of the subscriber identity information by associating subscriber identity information with a user's desktop, bookmarks, applications, or short-cuts a particular user has corresponding to the predetermined profile stored on the wireless communication device. The processor can be further programmed to deny access to the predetermined profile when a SIM card other than the SIM card containing the portion of the subscriber identity information is coupled to the wireless communication device. The processor can be further programmed to synchronize with an external computing device only information associated with the predetermined profile when the SIM card containing the portion of the subscriber identity information is coupled to the wireless communication device. The processor can be further programmed to enable access to public files notwithstanding a coupling of a SIM card with the wireless communication device.

In a third embodiment of the present invention, a wireless communication device having a system of adapting a phone profile to a Subscriber Identity Module (SIM) card can include a transceiver and a processor coupled to the transceiver that is controlled under an operating system allowing multiple profiles. The processor can be programmed to extract subscriber identity information from the SIM card when the SIM card is coupled to the wireless communication device, associate at least a portion of the subscriber identity information from the SIM card with at least a predetermined profile stored on the wireless communication device, and enable access to the predetermined profile only when the portion of the subscriber identity information is associated with the predetermined profile stored on the wireless communication device. The processor can be further programmed to store separate profiles on the wireless communication device for each SIM card used on the wireless communication device or store separate multiple profiles on the wireless communication device for each SIM card used on the wireless communication device. The processor can be further programmed to deny access to the predetermined profile when a SIM card other than the SIM card containing the portion of the subscriber identity information is coupled to the wireless communication device. The processor can also be programmed to synchronize with an external computing device only information associated with the predetermined profile when the SIM card containing the portion of the subscriber identity information is coupled to the wireless communication device.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a flow chart of a method of associating a user profile with a SIM card in accordance with an embodiment of the present invention.

FIG. 2 is a block diagram illustrating how a profile on a wireless communication device is associated with a corresponding SIM card in accordance with an embodiment of the present invention.

FIG. 3 is a block diagram illustrating how a single SIM card can be associated with multiple profiles on a wireless communication device in accordance with an embodiment of the present invention.

FIG. 4 is a block diagram illustrating the synchronization of a wireless communication device with a computer where the communication device has an associated profile associated with a SIM card in accordance with an embodiment of the present invention.

FIG. 5 is an illustration of a system for associating a user profile with a SIM card in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

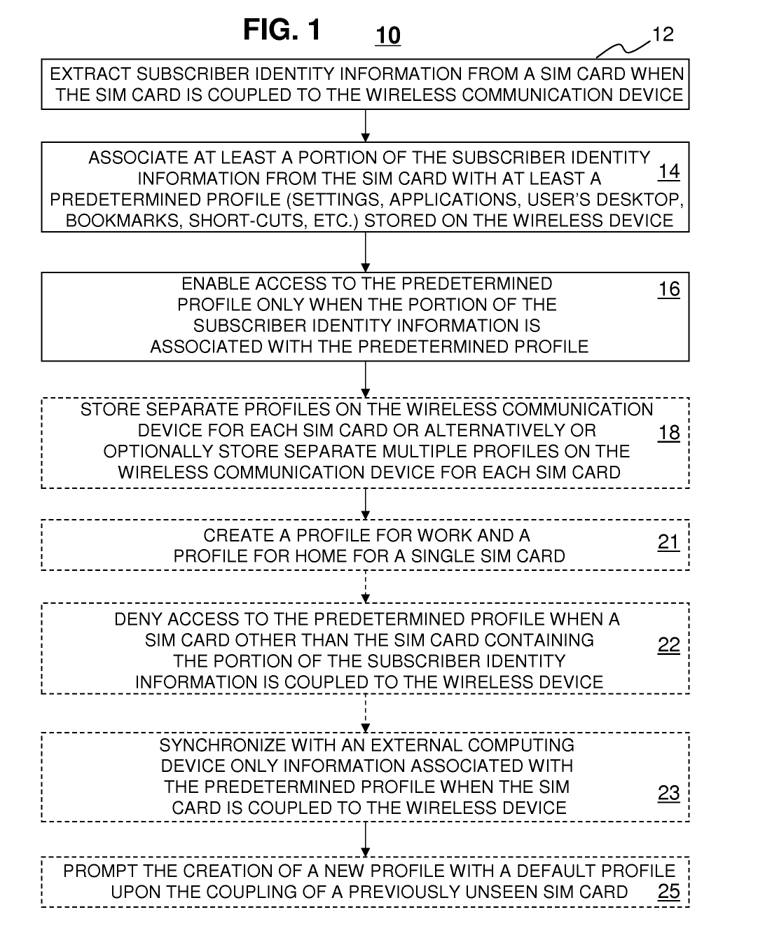

Referring to FIG. 1, a method 10 of adapting a phone profile in a wireless communication device to a Subscriber Identity Module (SIM) card can include the step 12 of extracting subscriber identity information from a SIM card when the SIM card is coupled to the wireless communication device, associating at least a portion of the subscriber identity information from the SIM card with at least a predetermined profile stored on the wireless communication device at step 14, and enabling access to the predetermined profile only when the portion of the subscriber identity information is associated with the predetermined profile stored on the wireless communication device at step 16. The method 10 can further include at step 18 storing separate profiles on the wireless communication device for each SIM card used on the wireless communication device or alternatively or optionally storing separate multiple profiles on the wireless communication device for each SIM card used on the wireless communication device. Separate multiple profiles can be created at step 21 for example by creating a profile at for work and a profile for home for a single SIM card used on the wireless communication device. The step of associating can include associating subscriber identity information with settings and applications for a particular user corresponding to the predetermined profile. For example, the subscriber identity information can be associated with a user's desktop, bookmarks, applications, or short-cuts a particular user has corresponding to the predetermined profile stored on the wireless communication device. The method 10 can further include the step 22 of denying access to the predetermined profile when a SIM card other than the SIM card containing the portion of the subscriber identity information is coupled to the wireless communication device. The method 10 can further include the step 23 of synchronizing with an external computing device only information associated with the predetermined profile when the SIM card containing the portion of the subscriber identity information is coupled to the wireless communication device. The method 10 can also prompt a user at step 25 for the creation of a new profile with a default profile upon the coupling of a previously unseen SIM card with the wireless communication device. Note, the method 10 can also enable access to public files notwithstanding a coupling of a SIM card with the wireless communication device.

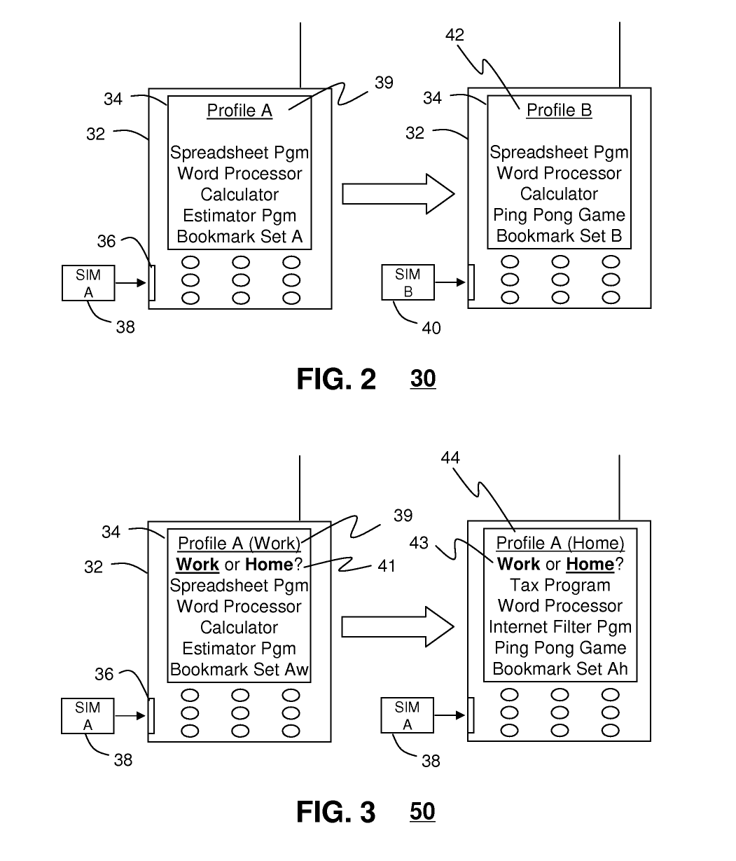

Embodiments herein can be implemented in a wide variety of exemplary ways that can enable a cell phone user to share a phone securely without having to recreate or reset settings or profiles on the phone as shown in FIGS. 2 and 3. In the example where a family shares a smart phone among family members, a phone 32 in a system 30 can save and use the personal settings and applications of each family member. For example, the father as user “A” and owner of SIM card 38 or “A” can install applications and configure his desktop and phone list for his job in a profile 39 or profile A. The profile 39 can be presented on a user interface or display 34 of the device 32 and can only be seen when the SIM card 38 is coupled to the wireless device 32 (in this instance via SIM Card Slot or port 36). The father can take his SIM card 38 out and in the evening, the mother or User “B” may use the smart phone when shopping, and load up bookmarks for her favorite stores while using SIM card 40 or “B” that corresponds to profile 42 or “B” stored on the wireless device 32. The son may have games loaded that he uses on the weekend with yet another SIM card (not shown). This arrangement can become quite cluttered if the father has to sort through the games and shopping bookmarks to get to his business applications. Instead, embodiments in accordance with the present invention store separate profiles (desktop, bookmarks, applications short cuts, and the like) for each SIM card used with the phone. As shown, the father or user A can have profile A or 39 that includes his desktop, programs, bookmarks, and other settings. In particular, profile 39 can have a spreadsheet program, a word processor, a calculator, an estimator program, and the father's set of bookmarks that is stored in the wireless device 32 and associated with the SIM card 38. Similarly, profile 42 can have a spreadsheet program, a word processor, a calculator, a game, and the mother's bookmarks that is stored in the wireless device 32 and associated with SIM card 40. In this manner, multiple users will have a private place to store their settings and applications so they will not interfere with other users. Each user can then see their personal desktop with only their applications and preferences (phone book, bookmarks, etc), based on which SIM card is currently installed in the wireless device 32.

As an added or optional feature, a single user having a single SIM card (38) may want to configure their device for multiple profiles, for example for home use and for office use as illustrated in the system 50 of FIG. 3. In this way a user's job applications and information will not clutter up their personal desktop and their personal settings won't interfere with his or her job applications. The phone can be programmed to automatically switch to the appropriate profile based on a Caller ID of an incoming call, or based on a GPS location, or simply based on a user selection. In this example, the user profile 39 can correspond to a work profile as can be selected among selections 41 on the user interface 34. Likewise, a user profile 44 can correspond to a home profile as can be selected among selections 43 on the user interface 34. Thus, the same SIM card 38 can enable two different profiles for the same user (or different users if desired). Using Caller ID in a similar fashion to set a user profile can allow the user instant access to job applications when a co-worker calls and instant access to their personal phone book and applications when a friend calls. Further note, there can be common or public areas available to all users so that companies or families may store applications and information for all employees or family members to use. Also note, the phone can also contain a default profile that would be used when a new SIM card is installed.

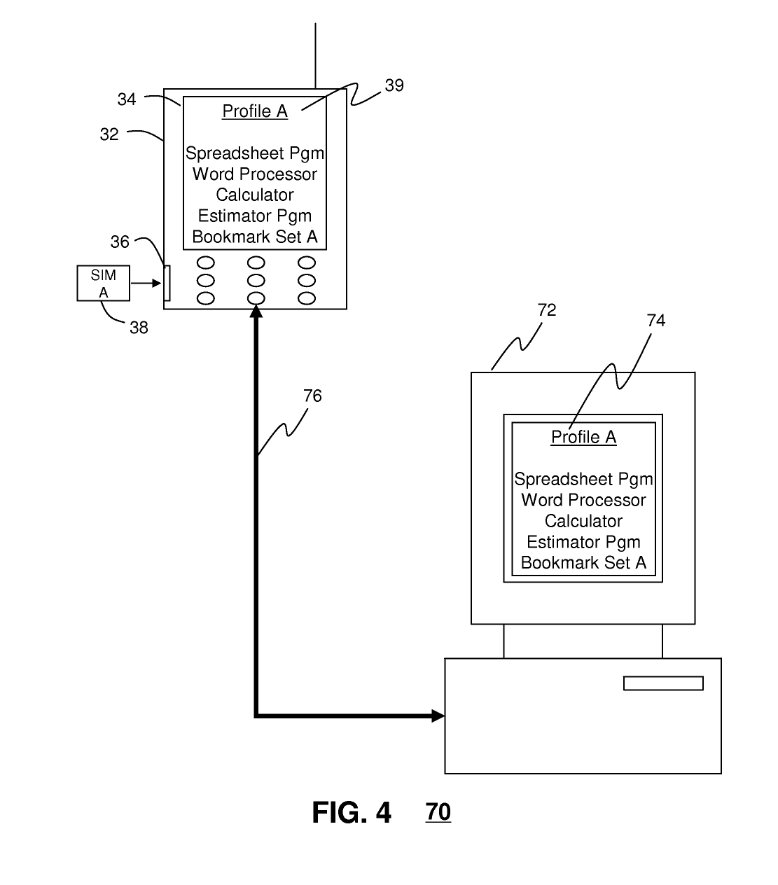

Referring to FIG. 4, a system 70 including the wireless communication device 32 of FIGS. 2 and 3 is shown coupled to the computing device 72 for synchronization in accordance with an embodiment of the present invention. The techniques previously described with regards to FIGS. 1-3 can be used here as a secure method of identifying the wireless device 32 to the computing device 72 for purposes of synchronization. For example, the wireless communication device 32 can contain data for multiple accounts associated with different SIM cards. In accordance with the embodiments herein, the system 70 can be configured to only synchronize the account data corresponding to the currently installed SIM card with the corresponding account on the computing device 72. In this manner, data and settings in profile 39 or profile A will be synchronized with data and setting in a corresponding profile 74 or profile A in the computing device 72 (via connection 76). Other account information belonging to other people (corresponding to other SIM cards) would not be transferred to the computing device 72 during such synchronization. Likewise, a person using multiple devices can insert their SIM into each of the devices and then synchronize to the computing device 72. The computing device 72 can then securely transfer this synchronized information to multiple devices as needed.

The SIM card does an excellent job of holding secure account ID information and can contain logic for challenge/response validation. The SIM card scheme is as secure as a login/password system for providing your account ID to a device such as an organizer or computer. Each new user on a particular device can get their own new profile. As with other types of systems that support more than one user, the first time a user can log on (or in this case puts their SIM card in the device) and the user can get a default new user account. Such default new user account can enable a new user to store their files in either public areas for others to view or in secure areas that can only be visible to the new user when his or her SIM card is in the device. Once created, the user can then synchronize their personal account with other devices if desired. Only a “super user” or “administrator” can remove his account from the device.

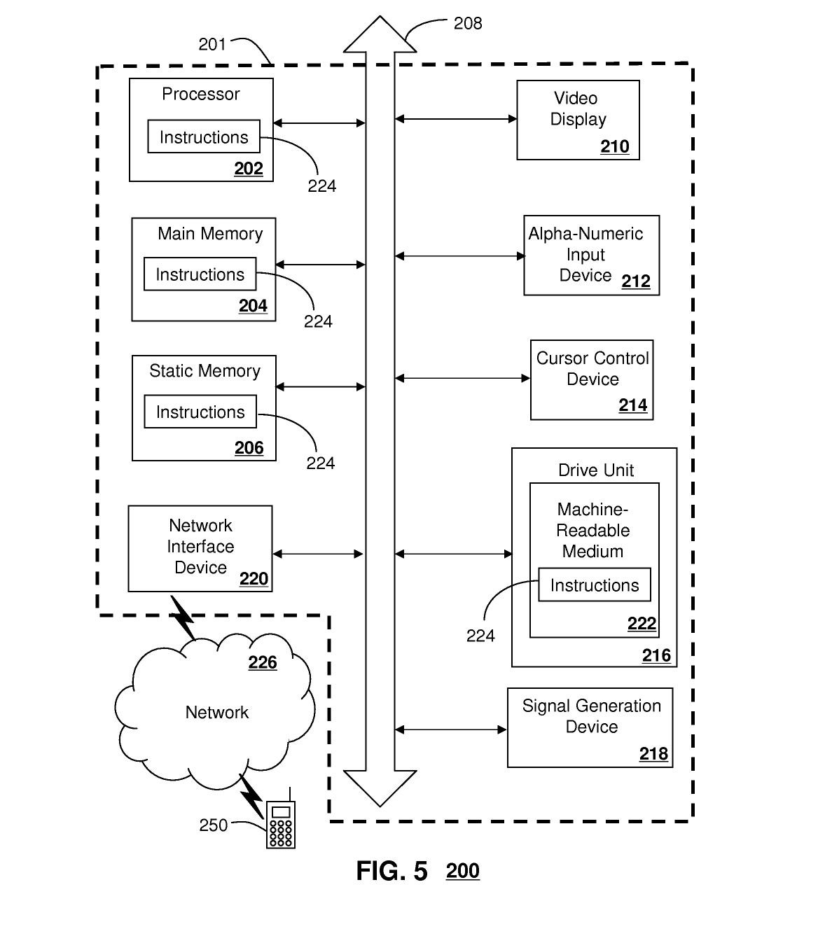

FIG. 5 depicts an exemplary diagrammatic representation of a machine in the form of a computer system 200 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 201 and a sending device 250 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 200 can include a controller or processor 202 (e.g., a central processing unit (CPU), a graphics processing unit (GPU, or both), a main memory 204 and a static memory 206, which communicate with each other via a bus 208. The computer system 200 may further include a presentation device such as a video display unit 210 (e.g., a liquid crystal display (LCD), a flat panel, a solid state display, or a cathode ray tube (CRT)). The computer system 200 may include an input device 212 (e.g., a keyboard), a cursor control device 214 (e.g., a mouse), a disk drive unit 216, a signal generation device 218 (e.g., a speaker or remote control that can also serve as a presentation device) and a network interface device or transceiver 220. Of course, in the embodiments disclosed, many of these items are optional.

The disk drive unit 216 may include a machine-readable medium 222 on which is stored one or more sets of instructions (e.g., software 224) embodying any one or more of the methodologies or functions described herein, including those methods illustrated above. The instructions 224 may also reside, completely or at least partially, within the main memory 204, the static memory 206, and/or within the processor 202 during execution thereof by the computer system 200. The main memory 204 and the processor 202 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 224, or that which receives and executes instructions 224 from a propagated signal so that a device connected to a network environment 226 can send or receive voice, video or data, and to communicate over the network 226 using the instructions 224. The instructions 224 may further be transmitted or received over a network 226 via the network interface device or transceiver 220.

While the machine-readable medium 222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of adapting a phone profile in a wireless communication device to a Subscriber Identity Module (SIM) card, comprising the steps of:
extracting subscriber identity information from a SIM card when the SIM card is coupled to the wireless communication device;
associating at least a portion of the subscriber identity information from the SIM card with at least a predetermined profile stored on the wireless communication device; and
enabling access to the predetermined profile only when the portion of the subscriber identity information is associated with the predetermined profile stored on the wireless communication device.

2. The method of claim 1, wherein the method further comprises the step of storing separate profiles on the wireless communication device for each SIM card used on the wireless communication device.

3. The method of claim 1, wherein the method further comprises the step of storing separate multiple profiles on the wireless communication device for each SIM card used on the wireless communication device.

4. The method of claim 3, wherein the step of creating separate multiple profiles comprises creating a profile for work and a profile for home for a single SIM card used on the wireless communication device.

5. The method of claim 1, wherein the step of associating comprises associating subscriber identity information with settings and applications for a particular user corresponding to the predetermined profile.

6. The method of claim 1, wherein the step of associating comprises associating subscriber identity information with a user's desktop, bookmarks, applications, or short-cuts a particular user has corresponding to the predetermined profile stored on the wireless communication device.

7. The method of claim 1, wherein the method can further comprise the step of denying access to the predetermined profile when a SIM card other than the SIM card containing the portion of the subscriber identity information is coupled to the wireless communication device.

8. The method of claim 1, wherein the method further comprises the step of synchronizing with an external computing device only information associated with the predetermined profile when the SIM card containing the portion of the subscriber identity information is coupled to the wireless communication device.

9. The method of claim 1, wherein the method further comprises the step of prompting the creation of a new profile with a default profile upon the coupling of a previously unseen SIM card with the wireless communication device.

10. A system of adapting a phone profile in a wireless communication device to a Subscriber Identity Module (SIM) card, comprising:
a transceiver; and
a processor coupled to the transceiver, wherein the processor is programmed to:
extract subscriber identity information from the SIM card when the SIM card is coupled to the wireless communication device;
associate at least a portion of the subscriber identity information from the SIM card with at least a predetermined profile stored on the wireless communication device; and
enable access to the predetermined profile only when the portion of the subscriber identity information is associated with the predetermined profile stored on the wireless communication device.

11. The system of claim 10, wherein the processor is further programmed to store separate profiles on the wireless communication device for each SIM card used on the wireless communication device or store separate multiple profiles on the wireless communication device for each SIM card used on the wireless communication device.

12. The system of claim 10, wherein system associates at least a portion of the subscriber identity information by associating subscriber identity information with settings and applications for a particular user corresponding to the predetermined profile.

13. The system of claim 10, wherein the system associates at least a portion of the subscriber identity information by associating subscriber identity information with a user's desktop, bookmarks, applications, or short-cuts a particular user has corresponding to the predetermined profile stored on the wireless communication device.

14. The system of claim 10, wherein the processor can be further programmed to deny access to the predetermined profile when a SIM card other than the SIM card containing the portion of the subscriber identity information is coupled to the wireless communication device.

15. The system of claim 10, wherein the processor can be further programmed to synchronize with an external computing device only information associated with the predetermined profile when the SIM card containing the portion of the subscriber identity information is coupled to the wireless communication device.

16. The system of claim 10, wherein the processor can be further programmed to enable access to public files notwithstanding a coupling of a SIM card with the wireless communication device.

17. A wireless communication device having a system of adapting a phone profile to a Subscriber Identity Module (SIM) card, comprising:
a transceiver; and
a processor coupled to the transceiver and controlled under an operating system allowing multiple profiles, wherein the processor is programmed to:
extract subscriber identity information from the SIM card when the SIM card is coupled to the wireless communication device;
associate at least a portion of the subscriber identity information from the SIM card with at least a predetermined profile stored on the wireless communication device; and
enable access to the predetermined profile only when the portion of the subscriber identity information is associated with the predetermined profile stored on the wireless communication device.

18. The wireless communication device of claim 17, wherein the processor is further programmed to store separate profiles on the wireless communication device for each SIM card used on the wireless communication device or store separate multiple profiles on the wireless communication device for each SIM card used on the wireless communication device.

19. The wireless communication device of claim 17, wherein the processor can be further programmed to deny access to the predetermined profile when a SIM card other than the SIM card containing the portion of the subscriber identity information is coupled to the wireless communication device.

20. The wireless communication device of claim 17, wherein the processor can be further programmed to synchronize with an external computing device only information associated with the predetermined profile when the SIM card containing the portion of the subscriber identity information is coupled to the wireless communication device.
